(19) United States
(12) Patent Application Publication
(10) Pub. No.: US 2021/0225141 A1
(43) Pub. Date: Jul. 22, 2021

(54) Discreet Solution to Signal Stealing and Reducing Game Duration

(71) Applicant: SPORTS SOLUTIONS and INNOVATIONS LLC, Salem, NH (US)

(72) Inventor: Steven Petrillo, Salem, NH (US)

(21) Appl. No.: 17/155,326

(22) Filed: Jan. 22, 2021

Related U.S. Application Data
(60) Provisional application No. 62/964,387, filed on Jan. 22, 2020.
(60) Provisional application No. 63/014,299, filed on Apr. 23, 2020.

(51) Int. Cl. G08B 9/00; G08B 6/00

(52) U.S. Cl. CPC G08B 9/00; G08B 6/00

(57) ABSTRACT

A system for covert communication including a transmitter set at least one receiver set comprising an antenna, a battery and battery case, a signal receiving device, a signal conditioning device, a vibration disc and a housing wherein the antenna, the battery and battery case, the signal receiving device and signal conditioning device are contained within the housing.

### CROSS REFERENCE TO RELATED APPLICATION

This application claims the benefit of and takes priority from U.S. Provisional Patent Application Ser. No. 62/964,387 filed on Jan. 22, 2020 and U.S. Provisional Patent Application Ser. No. 63/014,299 filed on Apr. 23, 2020, the contents of which are herein incorporated by reference.

### BACKGROUND OF THE INVENTION

### Field of the Invention

The present invention relates generally to systems and accompanying apparatuses for covert or discreet input and feedback communication and more particularly to communication methods in athletic endeavors and method between catchers and pitchers solve current sign stealing in baseball and softball as well as to lessen the time required to complete athletic activities.

### Description of the Related Art

Presently, communications in athletics have become as much a part of the press surrounding sport as the results of the games. between baseball and softball catchers, pitchers, coaches, is very difficult to disguise, especially with evolving enhancements in technology. For example, when a baseball/softball catcher (or coach sometimes), is advising or recommending types of pitches for the pitcher to throw, opposing players and teams are able to determine which pitch the pitcher may be throwing, by means of interpreting the number of fingers that the catcher shows to the pitcher, as one example.

This has been a heightened problem in baseball/softball because it is considered “sign stealing”, it gives an unfair advantage to the hitter, because he/she often knows what type of pitch the pitcher will be throwing which clearly increases the batter's probability of making contact with such pitch(s). This has been an increasing problem, especially due to technological advances, such as discreet cameras that can zoom in and provide “sign stealing” information to opposing teams, as one of many examples of methods to “steal signs” that exist presently and in the future.

Presently, communications in athletics have become as much a part of the press surrounding sport as the results of the games between baseball and softball catchers, pitchers, coaches, is very difficult to disguise, especially with evolving enhancements in technology. For example, when a baseball/softball catcher (or coach sometimes), is advising or recommending types of pitches for the pitcher to throw, opposing players and teams are able to determine which pitch the pitcher may be throwing, by means of interpreting the number of fingers that the catcher shows to the pitcher, as one example.

Obviously, strategy and gamesmanship are affected as well, if not stunted. However, possibly the largest negative impact may focus on the affects evolving from the fact that athletic activities and competitions are lengthened, which is currently harming the game of major league baseball.

Additionally, a Major League Baseball game's duration has consistently been getting longer and longer. According to MLB.com Statistics: In 2019, the average Major League Baseball game lasted hours and 10 minutes! Unfortunately, as the game duration increases, the attendance has conversely decreased, as well as the television viewers ratings.

The continuous increase in game duration can be attributed to several factors, all of which will be positively impacted by this system: Frequent, unnecessary catcher and pitcher huddles on the mound in order to “get on the same page” regarding pitch calling. As Justin Verlander stated, “The signs are getting so much more advanced to protect against sign stealing” A catcher walks 60 feet 6 inches to the mound, secretly they discuss pitch changes, then the catcher travels back another 60 feet 6 inches then sets back up behind the plate. In 2017, data shows that the 2 catchers of an average MLB game walked an average of a combined 6.7 miles in 9 innings of play for “mound visits”. If the catcher jogged at 4 miles per hour both ways on every mound visit, this equates to a staggering 1 hour and 40 minutes of added time to an already long game. Longer time between pitches currently, because of the need to ensure that the pitcher/catcher communications are as discreet as possible, and fully comprehended by the pitcher (to avoid pass balls, as well as well as preventing the batter from being hit by a pitch).

It is well documented that the duration of Major League Baseball games is growing due to interruptions, especially frequent mound visits. Fans often illustrate their distain with jeering or booing, and often times don't stay for the entirety of the game, especially when they take their children to a game because the “pace of play” has slowed down, despite some recent rule changes that have been implemented. Not only does such additional extension of time per game that this system will significantly decrease, but also keep in mind that these far too frequent mound visits inevitably effect the pitcher who is “in his/her zone,” their rhythm is often thrown off.

When baseball/softball pitchers are “in a zone”, most pitchers do not like to be distracted by another mound visit that undoubtedly interrupts his/her momentum, impacting the flow of the game. The psyche of pitchers has shown to immensely impact their performance; this system will allow the pitcher to allocate their full focus on their task at hand-Striking out the batter at the plate! Just as a quarterback who is “in their zone” loves a no huddle drive to keep his/her momentum and hot hand going, if the flow of the game or drive is interrupted by an opposing player laying on the ground due to an injury or pretending to be injured, the quarterback always shows dismay on his face.

It's well documented that Major League Baseball games are getting longer and longer due to interruptions, especially frequent mound visits. Fans often times get bored and don't complete watching the full game, especially when they take their children to a game. The pace of the game being interrupted frequently, has resulted in a decrease in television interest, as well as attendance of games. Such additional increase in current game duration will dramatically decrease, as importantly, the pitcher's rhythm will not be interrupted, allowing them to remain “in the zone.”

Thus, a new set of rules implemented by Major League baseball to speed up “Pace of Play” includes the allocation of only 5 mound visits per team, during a 9-inning game. This makes mound visits very precious and extremely valuable and only to be used for strategic discussions (how to address runners on base, etc.) Thus, this rule will render mound visits for the pitcher and catcher to “be on the same page” regarding pitch signals a thing of the past. Many of these scenarios result from miscommunication of finger/hand movements or calming e down the pitcher as the psyche of pitchers has shown to immensely impact their performance.

Therefore, discreet and efficient communications between players in Major League Baseball can be highly beneficial and some system even disclose wearable wireless electronic devices capable of providing communications. Wireless communications between wireless electronic devices can be impaired by a human body. However, when some wireless electronic devices are coupled to a hand or a face of a person, such coupling may harm communications by impairing transmission and/or reception quality. Accordingly, some wireless electronic devices are designed to reduce or compensate for the effects of a human body on wireless communications. Moreover, providing wireless communications through the air may consume significant amounts of power of wireless electronic devices and may have security vulnerabilities.

### SUMMARY OF THE INVENTION

The instant apparatus and system, as illustrated herein, is clearly not anticipated, rendered obvious, or even present in any of the prior art mechanisms, either alone or in any combination thereof. The versatile system, method and series of apparatuses relating to systems and accompanying apparatuses for covert or discreet input and feedback communication and more particularly to communication methods in athletic endeavors and method between catchers and pitchers solve current sign stealing in baseball and softball as well as to lessen the time required to complete athletic activities are illustrated. Thus, the several embodiments of the instant apparatus are illustrated herein.

It is also an additional object of the instant system to have a novel communication system that is portable, precise and easy to use. It is an objective of the instant system to facilitate a baseball or softball pitcher in focusing on the task at hand, instead of trying to accurately see and identify which pitch option the catcher is displaying through visible hand/finger movements.

It is an objective of the instant system to expedite the time required to ascertain the pitch type and location, while being very simple to use, non-invasive to individual(s) possessing either transmission or receiver mini apparatus/sensor, much faster in nature than concurrent communication manners so as to positively impact the pace of the game.

It is additionally an objective of the instant system to introduce a system which is extremely private/secure, exceptionally effective in eradicating sign stealing in baseball or softball, as well as greatly enhancing the flow of the game.

It is an objective of the instant system to facilitate communications between a football coach and a quarterback.

It is an objective of the instant system to facilitate communications between a football quarterback and the other members of an offensive football team.

It is an objective of the instant system to facilitate communications between a football coach and the captain of the defense football team.

It is an objective of the instant system to facilitate communications between a captain of the defense and the other members of a defensive football team.

It is an objective of the instant system to facilitate communications between a football coach and a mike linebacker of the defense football team.

It is an objective of the instant system to facilitate communications between a mike linebacker and the other members of a defensive football team.

It is an objective of the instant system to facilitate communications in a no huddle drive in a football contest. It is also an object of the instant system to facilitate communications under loud conditions in a football contest. It is an objective of the instant system to facilitate communications for a football team while a quarterback is calling audibles.

An additional objective of the instant system to facilitate communications between hunters in different environments wherein verbal communication would blow the cover of the hunting team, but the communication could be necessary to save lives and allow for attainment of goals as well.

It is an objective of the instant system to facilitate communications between military and police and emergency first responders such as firefighter and EMT's. The system will also assist in covert operations signaling, for agencies such as the Central Intelligence Bureau (CIA) and Federal Bureau of Investigation (FBI). The system will also assist in special operations and special forces activities including Navy SEALS, Army Rangers, Delta Force, particularly when team members are out the line of sight and hand gestures are not an option.

In one embodiment, it is an objective of the instant system to the communication system may comprise a singular button and communication may be achieved by utilizing a pattern combining single and multiple clicks via haptic technology. Alternatively, the communication system may utilize multiple buttons to transmit different signals.

In certain embodiments, an objective of the instant system is to the communication system may comprise a directional transmitter configured to transmit a directional signal substantially parallel to and/or generally in a line of sight of a receiver mechanism. A uniform may comprise an omnidirectional receiver configured to receive the directional signal transmitted by the directional transmitter; and an alert mechanism configured to output feedback to an individual equipped with the uniform in response to the omnidirectional receiver receiving the directional signal.

In an additional embodiment, the communication system may utilize an omnidirectional transmitter configured to transmit an omnidirectional signal. The uniform may incorporate a directional receiver configured to receive the omnidirectional signal transmitted by the omnidirectional transmitter; and a locking mechanism configured to prevent the firearm from firing, in response to the directional receiver receiving the omnidirectional signal.

In one embodiment, a communication pod comprises a directional transmitter configured to transmit a directional signal generally along a path in which a directional receiver is located. A handheld or wearable article comprises an omnidirectional transmitter configured to transmit an omnidirectional signal; an omnidirectional receiver configured to receive the directional signal transmitted by the directional transmitter; and an alert mechanism configured to output feedback to an individual equipped with the handheld or wearable article in response to the omnidirectional receiver receiving the directional signal. The directional receiver is configured to receive the omnidirectional signal transmitted by the omnidirectional transmitter.

In certain embodiments, the tactile (vibrating receiver) may be worn on the forearm/wrist, ankle, lower leg, lower/center back, hip (belt line), collar bone, and neck, where the body is likely to pick up slight vibration. The vibration is strong enough such that it can be felt over crowd noise. In addition, the receiver is water and heat resistant and it has an on/off switch.

In certain embodiments, a transmitter user may wear a silicone rubber wristband that is durable, sweatproof, and can hold a battery capable to last 10-12 hours, wherein the battery may be a common CR2032—3 volt, lithium coin battery (button battery) or a rechargeable lithium ion or other similar battery that could be charged either wirelessly or through wired charging apparatus.

In a someone different direction utilizing the human ear, there are two ways for humans to process sound. One way is through air conduction, and the other is through bone conduction. Air conduction is when sound travels through the air and directly into one's eardrums. This process is described as sound waves entering the outer ear, or pinna . . . from there, the sound goes into the air-filled middle ear, which includes the auditory canal and the eardrum. On the other side of the eardrum, there are three small bones, the ossicles, which are attached to it. They transmit the vibration to the cochlea, a fluid-filled structure that takes those vibrations and converts them to electrical impulses that are sent to the brain. This allows humans to hear sound that is transmitted from their surroundings.

Bone conduction thus occurs when sound vibrates along the bones in one's skull to the inner ear housing the organs for hearing and balance. The vibration is also carried throughout the rest of the skull. Lower frequency vibrations have a greater effect on bone conduction, allowing one to hear these more readily than higher frequencies. For example, bone conduction is how one perceives their own voice. Because skulls conduct lower frequencies, one often perceives their own voice as being much lower and fuller than when it is recorded and played back. When it is recorded and played back, a different type of conduction, air conduction, is utilized, which allows sound to transmit through the air and directly into one's eardrum at a higher frequency.

Interestingly, bone conduction technology hearing devices are becoming increasingly used instead of bone anchored hearing aids because of how the technology has improved over the years. A bone conduction hearing device is an alternative to a regular hearing aid for those with problems in their outer or middle ears. It transfers sound by bone vibration directly to the cochlea, bypassing the outer and the middle ear. This means it is useful for conductive and mixed hearing losses. A bone conduction hearing device relies on a working cochlea to send sound to the brain.

In some embodiments, the receiver and/or the transmitter may be integrated into the apparel for pitcher and/or catcher. The receiver may rest on shoulders or collar bone such that the system may utilize bone conduction technology to receive a signal and convert into sound only audible to the pitcher.

Bone conduction makes sound more audible and today, bone conduction is being used in technological advancements from hearing aids to headphones. Because hearing loss is most often caused from damage to the eardrums, bone conduction is well suited for hearing aid technology because it allows vibrations to be transferred from the world, into one's skull and transferred to the brain. These devices sit on the side of one's head, as opposed to in the ear. Similar to hearing aids, several companies have developed bone conduction headphones for consumer purchase. These headphones also sit on the side of one's head. They are often marketed as devices which allow for safer workouts as one can hear the music through bone conduction and be aware of traffic or other people around through air conduction.

A bone conduction hearing device is compatible with hearing loop (telecoil) systems. A user can select to pick up sound through the microphone, through the loop, or through a combination of both microphone and loop. This means you can take advantage of assistive listening devices, neckloops or switching to ‘T’ in places displaying the ‘T’ symbol. The bone conduction hearing device processor may have the telecoil feature integrated within it. Otherwise a telecoil accessory can be plugged into the processor when needed.

Bone conduction is the conduction of sound to the inner ear primarily through the bones of the skull, allowing the hearer to perceive audio content without blocking the ear canal. Bone conduction transmission occurs constantly as sound waves vibrate bone, specifically the bones in the skull, although it is hard for the average individual to distinguish sound being conveyed through the bone as opposed to sound being conveyed through air via the ear canal. Intentional transmission of sound through bone can be used with individuals with normal hearing—as with bone-conduction headphones—or as a treatment option for certain types of hearing impairment. Bone generally conveys lower-frequency sounds better than higher frequency sound. Bone conduction is the conduction of sound to the inner ear primarily through the bones of the skull, allowing the hearer to perceive audio content without blocking the ear canal.

Bone conduction transmission occurs constantly as sound waves vibrate bone, specifically the bones in the skull, although it is hard for the average individual to distinguish sound being conveyed through the bone as opposed to sound being conveyed through air via the ear canal. Intentional transmission of sound through bone can be used with individuals with normal hearing—as with bone-conduction headphones—or as a treatment option for certain types of hearing impairment. Bone generally conveys lower-frequency sounds better than higher frequency sound.

Bone conduction products are usually categorized into three groups: ordinary products, such as hands-free headsets or headphones, bone-anchored hearing aids and assistive listening devices and specialized communication products, many for underwater or high-noise environments. In one embodiment of a specialized communication product, a bone conduction speaker may be utilized by the pitcher, or other position players. The bone conduction speaker will be linked with the output transmission from a catcher, coach, manager or other control factor.

In one embodiment, the device may include a rubber over-molded, piezoelectric flexing disc that is approximately 40 millimeters (1.6 in) across and 6 millimeters (0.24 in) thick. A connecting cable may be contained within, or molded into the disc, resulting in a tough, waterproof assembly. In use, the speaker is strapped against one of the dome-shaped bone protrusions behind the ear and the sound will thus be contained within the head of the receiving person and not radiate outwardly to be head by others.

In another embodiment, to ensure complete safety from tampering with the equipment in any manner, a system akin to a bone anchored hearing aid may be utilized. A bone anchored hearing aid is considered a medical device whereas a bone conduction hearing aid is considered a “hearing aid”. While both devices directly stimulate the cochlea/inner ear, they are labeled differently for the FDA and insurance companies. A bone anchored hearing aid may utilize a titanium abutment that is surgically implanted while the bone conduction hearing aid is not implanted, it looks similar to a standard air conduction hearing aid.

In additional embodiments, a transmitter user of the wearable communication device, according to various embodiments, receives haptic feedback upon every push. In an additional embodiment, the transmitter may utilize a momentary switch that provides power to a transmitter IC chip with a RF/Bluetooth output antenna to provide robust signals. Concurrently, the receiver may utilize a battery driven power source with a corresponding RF/Bluetooth receiver IC chip that activates a piezo electric motor to vibrate. In certain embodiments, the system may use cellular, WIFI, and RF to improve signal strength.

In various embodiments, the transmitter may utilize a series of pitches. Three pitch types can be configured as 1. Dot (1 push), 2. Dot Dot (2 pushes), and 3. Dash (1 held push). In another embodiment, the system may utilize multiple different signals including a buzz, a dash, and a dot and in conjunction may comprise multiple different signal durations. For instance, one embodiment may utilize a long buzz and a short buzz to separately address the pitch type, the pitch location and the running game, i.e. base stealing. Thus, the system may have the capacity for one communication device to emit numerous different signals, for example address a buzz, a dash and/or a pinch, as in morse code type systems.

In another embodiment, the transmitter in the communication system may utilize rolling code technology, which protects against intruders by generating a new security code every time the catcher's input device is used. Therefore, the same code will never be used more than once and the stolen previously used codes are rendered useless to the intruders.

In another embodiment, Frequency-hopping Spread Spectrum (FHSS), a method of transmitting radio signals by rapidly changing the carrier frequency among many distinct frequencies occupying a large spectral band may be utilized in order to avoid interference, to prevent eavesdropping, and to enable code-division multiple access (CDMA) communications.

Methods of operating these and/or other systems are also contemplated herein, including for operations wherein signals between a pitcher and catcher, or even a coach and player, are achieved in a detectable manner. The method may include transmitting the signals from a first user-wearable device to a second device worn by a user or a group of devices worn by different users with an extensive range of 400 ft. The method may also include synchronizing multiple transmitters with multiple receivers to enable a secured and reliable communication network.

The features, aspects, advantages, and example embodiments described herein may be combined to realize yet further embodiments. In one embodiment a transmitter may comprise a single button device similar to a car remote key fob or a pressure sensitive actuator. The transmitter may be powered by a small internal battery or tethered to a larger power source worn on the person and a fob could be held in pocket or mounted to shin pads.

Additionally, a tethered device could hang from belt between legs so catcher's hand is a natural starting position allowing them to motion with the hand for inside vs outside pitches. For design considerations, Signal strength needs to be strong enough so as not to be drown out by other signals in stadium, i.e., cellular, Wi-Fi, rf, broadcast. Transmitter should be capable of sending burst and sustained signals, i.e., something similar to Morse code to transmit dots and dashes. This could either be used to increase the potential number of signals or reduce the number of presses to send a signal.

Investigating today's cellular communication capabilities, WI-FI, Bluetooth, GPS, etc. capabilities are designed to allow the user device to connect to the Internet, connect to other Bluetooth capable devices, identify the location of the user device, and otherwise communicate with other devices and systems, both near and far. This established, remote access may be established in wireless security systems through means of software, Remote Frequency Identification (RFID), Near Field Communications (NFC), Bluetooth®, Zigbee® or other means of short-range wireless protocol.

In one embodiment, the system may be designed and built out for one transmitter communicating to one receiver, for direct communications. In additional iterations, one or more transmitters signaling to one or more receivers may be utilized and networking of the transmitter/receiver. Expounding on this theory, one use case could be the catcher transmitting to the pitcher and infield and outfield and dugout, another use case could have the dugout transmitting to pitcher/catcher combo or to all players, while still another use case could have the catcher or dugout transmitting to pitcher or all players. In this manner, the instant system can be developed through iterations for the particular user application and therefore be designed to accommodate multiple use cases.

Addressing the types of signals to be utilized, in conjunction with the appropriate accompanying signal strength and range, obviously in one embodiment, as the system may feature non-visual, coupled with non-audio forms of communication, the system may utilize developed RF communication between the transmitter and receiver. A radio frequency (RF) system refers to a wireless electromagnetic signal used as a form of communications. Radio waves are a form of electromagnetic radiation with identified radio frequencies that range from 3 kHz to 300 GHz. Frequency refers to the rate of oscillation (of the radio waves). RF propagation occurs at the speed of light and does not need a medium like air in order to travel. RF waves occur naturally from sun flares, lightning, and from stars in space that radiate RF waves as they age. Humankind communicates with artificially created radio waves that oscillate at various chosen frequencies. RF communication is used in many industries including television broadcasting, radar systems, computer and mobile platform networks, remote control, remote metering/monitoring, and many more.

Radio frequency identification (RFID) is a wireless technology analogous to UPC barcodes. It is used worldwide for tracking and identifying consumer products. RFID transponders, or tags, are placed on portable objects to be tracked or identified, whether it is vehicles, livestock, baggage, or even people. RFID readers entail greater cost and complexity, so are typically stationary—installed in locations where the RFID data exchange is to take place. RFID is used in many applications including employee access control, asset tracking, electronic toll collection, and supply chain control.

In one embodiment, particularly suited for home and small environment usage may include a wireless personal area network (WPAN) is a low-powered PAN carried over a short-distance wireless network technology such as IrDA, Wireless USB, Bluetooth® and ZigBee®. This is particularly true as the reach of a WPAN normally varies from a few centimeters to a few meters.

In one embodiment of a WPAN arrangement, the control system may utilize a Bluetooth® transmitter/receiver. Bluetooth® is a wireless technology standard for exchanging data over short distances (using short-wavelength UHF radio waves in the ISM band from 2.400 to 2.485 GHz) from fixed and mobile devices, and building personal area networks (PANS).

In one embodiment, a network module may be a composite transmission network based on WIFI, Bluetooth and 2G/3G/4G communication, and automatically switches between connection modes according to various scenes.

While individual radio components such as mixers, filters, and power amplifiers can be classified according to operating frequency range, they cannot be strictly categorized by wireless standard (e.g., Wi-Fi, Bluetooth, etc.) because these devices only provide physical layer (PHY) support. In contrast, RF modules, transceivers, and SoCs often include data link layer support for one or more wireless communication protocols.

Investigating other possible mediums for achieving the requirements for the instant system, Bluetooth® is managed by the Bluetooth® Special Interest Group (SIG) and is based on the IEEE 802.15.1 standard for wireless personal area networks (WPANs). Bluetooth technology is designed to provide reliable, low-power, secure wireless communications over short-range and ad hoc-piconet-networks. Bluetooth operates in the unlicensed industrial, scientific and medical (ISM) band of 2.4 GHz.

Bluetooth is an open standard for short-range radio frequency (RF) communication and is used primarily to establish wireless personal area networks (WPAN), commonly referred to as ad hoc networks or piconets. A piconet is composed of two or more Bluetooth devices in close physical proximity that operate on the same channel using the same frequency hopping sequence and can scale to include up to seven active slave devices and up to 255 inactive slave devices. Bluetooth voice and data transfer technology has been integrated into many types of business and consumer devices, including cellular phones, personal digital assistants (PDA), laptops, automobiles, printers, and headsets.

Another possible platform, ZigBee®, like Bluetooth®, is a specification for communication in wireless personal area networks (WPANs). Designed to be low cost, low power and low duty cycle, ZigBee 73 technology is ideal for wireless sensor networks (WSNs) and other low power networks that span potentially large distances. ZigBee® normally builds upon the IEEE 802.15.4 standard, but adds mesh networking capability with multi-hop functionality and a routing protocol. Star networks as well as peer-to-peer (e.g., mesh and cluster tree) are supported, making ZigBee® networks dynamic, scalable, and decentralized.

ZigBee® technology is not meant to compete with technologies such as Wi-Fi (IEEE 802.11) or Bluetooth® (IEEE 802.15.1). Rather, ZigBee is designed for applications where data transfer rate is much less important than power efficiency, network size, and the capacity for ad hoc routing.

ZigBee® PRO is currently the latest and most feature rich ZigBee® stack available. In addition to a higher maximum number of devices (up to 65,560 in a single network), ZigBee® PRO supports three times as many hops as standard ZigBee 2007 and features advanced routing techniques, multicast functionality, and better network security.

Virtually all wireless local area networks (WLANs) are based upon the IEEE 802.11 standard for WLANs, called “Wi-Fi”. Nearly all of today's smartphones, laptops, tablets, and eBook readers are Wi-Fi capable—with very few exceptions. WLANs allow computer networks to be established for often a fraction of the cost of installing wired Ethernet, and can be used for temporary Wi-Fi connection “hotspots” in hotels, coffee shops, airports, libraries, and more. There are a range of standards within IEEE 802.11, each denoted by a letter suffix.

802.11b—This was the first Wi-Fi standard to be widely used for creating wireless computer networks. It operates in the unlicensed 2.4 GHz ISM frequency band and supports a maximum (nominal) data rate of 11 Mbit/s. 802.11b supports two modulation techniques: complementary code keying (CCK) and direct-sequence spread spectrum (DSSS).

802.11a—This standard, which is alphabetically first but developed slight later than 802.11b, operates in the less “crowded” 5 GHz frequency band. It includes support for a more advanced modulation scheme called orthogonal frequency division multiplexing (OFDM) resulting in faster data transfer rates than 802.11b—up to 54 Mbit/s.

802.11g—For now, this is still the most common Wi-Fi technology in use today. Operating in the 2.4 GHz band with OFDM support, 802.11g offers the higher data rates of 802.11a but without the greater costs associated with 5 GHz chips. 802.11g is also backwards compatible with 802.11b.

802.11n Featuring greatly extended range and improved data rates of up to 600 Mbit/s, this standard is quickly overtaking 802.11g. These improvements are thanks in large part to wider channel bandwidth and the addition of multiple-input multiple-output (MIMO) technology. Because 802.11n can operate in both the 2.4 GHz and 5 GHz bands, it can provide backward compatibility with previous standard at the cost of network speed.

802.11ac—This is the newest 802.11 standard, which is currently in the final stages of approval by the 802.11 Working Group. 802.11ac will offer channel bandwidth four times wider than previous standards, multi-user MIMO (MU-MIMO), highly sophisticated error correction, and data throughput rates in the Gbit/s range.

In another possible embodiment, a Global Positioning System (GPS) may be utilized. GPS is a satellite-based global navigation system that provides accurate location and time information anywhere on the planet. GPS is an important and ubiquitous technology used in applications ranging from commercial car-based navigation to advanced military target tracking and missile guidance systems. Most GPS satellites broadcast at the same two frequencies: 1575.42 MHz, called the “L1” band, and the 1227.60 MHz “L2” band. The signals are encoded using a CDMA spread-spectrum technique, allowing individual satellites to be distinguished from each other without co channel interference.

While Bluetooth, ZigBee, and Wi-Fi are some of the most prominent wireless standards, there are certainly many other important wireless technologies and evolving systems. Thus, the instant system is designed to be retrofitted or upgraded with any system in the foreseeable future of the art and future iterations should be open to changing technology.

Thus, the system can be configured to handle multiple channels of communications simultaneously and when utilizing an RF structure, the mechanism would be the same, i.e., RF signal sent from transmitter to receiver. In the case where the dugout controls the transmission signal, size is no longer a constraint and power can be scaled to ensure signal reaches outfielders. In the case where the catcher is still providing the signaling to all players, the device would still be constrained by size, weight, and profile.

Turning to material considerations for the receiver housing, in one embodiment, all components would be mounted in a custom 3D printed housing. The housing would be, ideally, unibody construction where the only entrance points for moisture or dust would be the vibration mechanism and access point for the batter installation. Each of those points would have some form of polymeric or other malleable seal, be it rubber, silicon, composite or the like, to prevent foreign object debris or moisture intrusion.

Clearly, in numerous embodiments, both the transmitter and the receiver housing should be heat-resistant, waterproof, sweat-proof and durable, but durability should not diminish the haptic feedback or signal strength.

Also, in some embodiments, the receiving apparatus may include wearable wireless devices like wrist bands and ankles bands or may be integrated into the jerseys, belts, or uniforms. In one embodiment, the system may be designed to be worn on the forearm with the device against the inside (palm side) of the arm. This location provides the greatest level of sensitivity by the wearer and would allow them to discern even slight vibration.

In additional embodiments or iterations, the device could be integrated into an ankle band, though that would likely be subject to more debris, or worn around the knee which is another known area of the human body particularly sensitive to vibration. These locations would require a change in device configuration as they offer a less flat surface on which to wear the device. The design would need to change from a relatively flat form factor to one that is rounded to follow the curve of the knee or ankle area. This may also require different size or roundness factor depending on the size of the user. For example professional athletes have much larger knee and ankle area than say a youth baseball player. Other possible locations could be at the small of the back, on the backside of the shoulder on the non-throwing arm, or on the waist. These locations have greater surface area and would allow for larger devices but present their own sets of problems, i.e. repeated twisting or bending motion may dislodge the device. Greater risk of impact due to collision would require a more robust device that adds to the weight, size, and profile.

Investigating possible embodiments of wearable devices, one attachment mechanism may be built into or inserted into the system into a sleeve on the forearm cuff. The wearable forearm band may be made from polymeric solutions, and in one embodiment neoprene rubber may be utilized (1) for moisture absorption and (2) flexible enough to move with the wearer and (3) the compression quality ensures that the vibration device will stay in close proximity to the arm thus increasing the probability of sensing the vibration

In a further embodiment, the device may be integrated into apparel and in some variations could be developed where the receiving devices may be integrated into the uniform. Obviously, limitations may be found regarding the areas of the body covered by the uniform that are also sensitive enough so as the player may readily discern a vibration from the device.

It is therefore an objective of the instant system to introduce a novel system, platform and method for mitigation of theft of communications over numerous mediums.

It is therefore an objective of the instant system to introduce a novel system, platform and method for mitigation of theft of communications over numerous mediums between participants in an athletic activity.

It is therefore an objective of the instant system introduce a novel system, platform and method for mitigation of theft of communications over numerous mediums between a series of participants, or at least two participants, in a baseball or softball practice.

It is therefore an objective of the instant system to introduce a novel system, platform and method for mitigation of theft of communications over numerous mediums between a series of participants, or at least two participants, in a baseball or softball game.

It is therefore an objective of the instant system to introduce a novel system, platform. and method mitigation of theft of communications over numerous mediums between a pitcher and catcher in baseball or softball.

It is therefore an objective of the instant system to introduce a novel system, platform. and method for mitigation of theft of communications over numerous mediums between a position player, or series of position players and a coach in baseball or softball.

It is therefore an objective of the instant system to introduce a novel system, platform and method for mitigation of theft of communications over numerous mediums between a pitcher and a coach in baseball or softball.

It is therefore an objective of the instant system to introduce a novel system, platform and method for mitigation of theft of signs between participants in an athletic activity.

It is therefore an objective of the instant system to introduce a novel system, platform and method for mitigation of theft of signs between a series of participants, or at least two participants, in a baseball or softball practice.

It is therefore an objective of the instant system to introduce a novel system, platform and method for mitigation of theft of signs between a series of participants, or at least two participants, in a baseball or softball game.

It is therefore an objective of the instant system to introduce a novel system, platform and method for mitigation of theft of signs between a pitcher and catcher in baseball or softball.

It is therefore an objective of the instant system to introduce a novel system, platform and method for mitigation of theft of signs between a position player, or series of position players and a coach in baseball or softball.

It is therefore an objective of the instant system to introduce a novel system, platform and method for mitigation of theft of signs between a pitcher and a coach in baseball or softball.

Some obvious design considerations include catcher-to-pitcher signal reception are range, robustness to pointing error (directionality) and reliability, formulating catcher transmission usability, one embodiment may include a singular button and communication may be achieved by utilizing a pattern combing single and multiple clicks.

In an additional embodiment, Multiple buttons may be utilized on order to achieve different signals. In one embodiment, haptic feedback may be to verify that the signal has been sent. Haptic technology, also known as kinaesthetic communication or 3D touch, refers to any technology that can create an experience of touch by applying forces, vibrations, or motions to the user. These technologies can be used to create virtual objects in a computer simulation, to control virtual objects, and to enhance remote control of machines and devices (telerobotics). Haptic devices may incorporate tactile sensors that measure forces exerted by the user on the interface. A tactile sensor is a device that measures information arising from physical interaction with its environment.

Tactile sensors are generally modeled after the biological sense of cutaneous touch which is capable of detecting stimuli resulting from mechanical stimulation, temperature, and pain (although pain sensing is not common in artificial tactile sensors). Tactile sensors are used in robotics, computer hardware and security systems. A common application of tactile sensors is in touchscreen devices on mobile phones and computing. Tactile sensors may be of different types including piezoresistive, piezoelectric, capacitive and elastoresistive sensors. Examples of simple haptic devices are common in the form of game controllers, joysticks, and steering wheels.

Addressing reception usability for a baseball or softball pitcher, one key factor includes haptic feedback strength, location on the pitcher, which could be on the ankle versus wrist versus other potential locations. In one embodiment, the transmitter (“TX”) and/or receiver (“RX”) may be integrated into apparel for pitcher and/or catcher, including but not limited to sweat band or ankle band. It is also an additional object of the instant system to have a novel communication system that is portable, precise and easy to use.

Moreover, not only can the system be used for athletic communication, the system is disposed to be perfectly convertible and transferable to hunting, paint gun, police and swat and military operations and particularly special forces.

These together, with the other objectives of the device, along with the various features of novelty, which characterize the apparatus, are pointed out with particularity in the claims annexed to and forming a part of this disclosure. For a better understanding of the mechanism, its operating advantages, and the specific objectives attained by its use, study of the accompanying drawings and descriptive matter, in which there are illustrations of the preferred embodiments, should be conducted.

There has thus been outlined, rather broadly, the more important features of the versatile integrated communication system, and series of accompanying systems and apparatuses and embodiments in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the system in detail, it is to be understood that the system is not limited in its application to the details of construction and to the arrangements of the components set forth in the following description or illustrated in the drawings. The system is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

While example aspects and features of this invention generally have been described above, the following detailed description, in conjunction with FIGS. 1-12, provides even more detailed examples of electronic devices and athletic performance communication and sensing systems and methods in accordance with examples of this invention, as well as example user interfaces for operating such systems and performing such methods. Those skilled in the art should understand, of course, that the following constitutes descriptions of examples of the invention and should not be construed as limiting the invention.

### BRIEF DESCRIPTION OF THE DRAWINGS

FIG. 1A is a schematic diagram illustrates the assembled components of one embodiment of the communication system including a vibration disc, a transmitter and a compression wrist cuff which can suffice as a transmitter or receiver in accordance with the present invention.

FIG. 1B illustrates the disassembled components of one embodiment of the communication system including a vibration disc, an antenna, a battery case, a transmitter and a compression wrist cuff which can suffice as a transmitter or receiver in accordance with the present invention.

FIG. 2 illustrates a diagram depicting the internal structures of one embodiment of the transmitter and the receiver of the present apparatus.

FIG. 3 is a schematic diagram illustrates various components including a receiver, a transmitter, and a vibration motor in accordance with the present invention.

FIG. 4 illustrates the disassembled components of one embodiment of the communication system including a transmitter, a compression wrist cuff and a vibration disc in accordance with the present invention.

FIG. 5 shows a schematic view of a first embodiment of the system in the form of a functional block circuit diagram.

FIG. 6 illustrates block descriptive diagrams of numerous embodiments of systems to be utilized. A radio frequency (RF) system refers to a wireless electromagnetic signal used as a form of communications.

FIG. 7 is a schematic diagram of a wearable electronic device illustrates some possible placement alternatives for transmitting and receiving apparatuses 30 in accordance with the invention.

Some placement alternatives include shoulders 31, wrists 32, hips 33, knees and ankles.

FIG. 8 illustrates some possible placement alternatives for transmitting and receiving apparatuses and particularly illustrates a transmitting or receiving apparatus, which may be a remote signal button, located within a baseball/softball glove of player.

FIGS. 9A-9D illustrates some possible usage alternatives for the transmitting and receiving apparatuses.

FIG. 10 is a diagram of one embodiment of a bone conduction device and sound to vibration transfer into a human skull, and to the brain to transmit sound waves.

FIG. 11 is a diagram illustrating the vibration of air as emanated by a normal sound for processing by the human ear, without a bone conduction device installed.

FIG. 12 is a diagram illustrating the vibration through a bone conduction device processing through the human ear and this means of transfer of communication is highly secure and cannot be detected in any manner by state of the art listen devices and the vibration is now internal.

### DETAILED DESCRIPTION OF THE SEVERAL EMBODIMENTS

The detailed description set forth below is intended as a description of presently preferred embodiments of the system and does not represent the only forms in which the instant system may be construed and/or utilized. However, it is to be understood that the same or equivalent functions may be accomplished by different embodiments and are also intended to be encompassed within the scope of the system.

As discussed at length herein, theft of communications, be it in athletics or other endeavors has proven to be a major issue. Plainly, some form of covert or discreet communication, that cannot readily be recognized or heard qualifies as the best and most sensible solution to eliminating theft, for example baseball “sign stealing” between a pitcher and catcher. Thus, the instant system provides a covert, effective communication system that actively eliminates the ability for onlookers to gain knowledge of the communication between catchers and pitchers in baseball/softball and thus will revolutionize several aspects of these athletic activities, as well many others.

That said, the optimal solution in eliminating such “sign stealing” because of the impossibility of gathering the current unfair advantage that has been an ongoing issue, especially in Major League Baseball, collegiate baseball/softball and even in high school baseball/softball. If the opposing team cannot see, nor hear the communications between the catcher or coach, as the initiator, to the pitcher, there is no way that they can “steal signs.” The possibility for the opponent to visually see and steal signs, creates an unfair advantage that has been an ongoing issue, especially in Major League Baseball, collegiate baseball/softball and even in high school baseball/softball.

The instant concept comprises a covert/discreet system in which a mini-input device, such as a switch, sends information wirelessly from an individual including but not limited to a baseball/softball catcher, to the pitcher's receiving mini device, which may be wearable and may be located in the inside of the pitcher's wristband, waistband, glove or any other portion of the body from which a user can easily ascertain the contents of the signal.

The non-audio input device or transmitter can be worn by the catcher or coach and is small enough to fit on a user's finger, much like a bandage or a piece of athletic tape, as one example. Such input device/transmitter can be placed anywhere on the back of the hand, finger or wrist of a catcher, coach or a field position player.

Additionally, the non-audio input device or transmitter may be located on inside of the catcher's mitt in an area wherein no other individual(s), nor technology such as cameras, may ascertain the catcher's hand movements as he/she is utilizing the mini device to provide information to the pitcher. The non-audio input device or transmitter may also be located anywhere on the body of a catcher, coach or a field position player body, but should be covered by a mitt or glover when the mini-input device/transmitter is being actively utilized to provide data or information. This allows the complete shielding of movement from the catcher's finger or hand movement while inputting a pitch type/location signal(s).

This input/transmitter information may produce a covert, secure, non-visual and non-audio feedback to the pitcher's receiving mini device/sensor, which is exhibited to the pitcher as a single vibration/pulse if the catcher or coach applies pressure/pushes the button once, indicating that pitch #1 is being suggested.

Alternatively, if the catcher or coach inputs two pushes signifying pitch #2, then the pitcher will receive two haptic, in one embodiment, pulses or vibrations via the user wearable, in one embodiment tactic, receiver. There a variety of ways, places and types of feedback sensors that the pitcher may use (inside of their wristband, waistline, sock etc. The communication is a strong, secure and wireless signal that is not impeded through apparel such as baseball/softball gloves and mitts, wrist bands, waistbands, socks, etc., whichever device is used. The catcher simply applies pressure to his/her interior, hidden from view input/transmitter device/sensor, using a very simplistic system—a sequential order, 1,2,3,4, 5 or any number of pushes or touches.

This discreet, secure and non-audio input is relayed to the pitcher as a single vibration/pulse for 1 push, 2 vibrations/pulses for 2 button pushes etc. Such replicated feedback is felt by the pitcher by means of his/her discreet, possibly wearable feedback sensor/device replicating the number of “pushes or touches” from the catcher. Once the pitcher agrees with the desired pitch type, the catcher can then send a second input to express pitch location (such as 1 vibration/pulse felt by the pitcher for inside to the batter, or 2 vibrations/pulses for the pitch to be away from the batter).

Furthermore, this covert/discreet/secure communication method does not give the batter any indication of both the pitch selected, nor the location. There are several current mini technologies currently available and inexpensive, that exist that may be used, such as a variety of sensors (haptic, tactile, button etc.) which can be wearable, adhered or in contact with the skin, sustain extreme temperatures and are water and sweat proof. The system can utilize a variety of already available technologies, as transmitters, receivers and as importantly for a secure communication in which a team “set” is synched solely by the set's transmitters and receivers, unable to be hacked into by anyone or any technology used by any team or individual.

Examples of such existing technologies, that may be integrated with this intellectual property, including but not limited to a system resembling an input of a doorbell, and thus one push is displayed as one feedback pulse or vibration. In an additional embodiment, a system reminiscent of communication between the updated versions of garage doors, featuring rolling or hopping code rolling code technology, protects against intruders by generating a new security code every time the catcher's or coach's input device/transmitter is used.

When this input device activates the intended individual(s)—the pitcher's feedback mechanism, a unique algorithm “rolls” the input device's code to one of more than 100 billion possible codes. The previously used code will be discarded, and the intended feedback devise/apparatus will know only to respond to the new code the next time input apparatus is used. The same code will never be used more than once. Therefore, stolen previously used codes are useless to intruders.

The signaling/communication may work by generating constantly changing codes given off by the catcher's input apparatus and received and “synced” only by the intended recipient(s) feedback device (pitchers, team manager, team pitching coach etc.) As mentioned, this is only one type of the users' options for a secure communication method. Any secure, encrypted wireless network, Bluetooth, etc. may be used. The secure communication (s) in which this intellectual property may be developed in the future and evolve as technology and cyber security evolves.

This intellectual property allows the users to have flexibility in deciding which communication method(s) they choose to utilize. Such a signal from a touch-based or button user interface device, in real time is received by uniquely synced receiver device(s) and may transmit such feedback as pulses or vibrations to the pitcher etc. The signal may include independent touches to the touch or push input device, for example a numerical sequence.

One “push or touch” would be replicated as one vibration or pulse to the pitcher, indicating that it is pitch #1, if the players had designated pitch #1 as being a fastball, the pitcher can shake his/her head no and the catcher will then send feedback for a different offered pitch the pitcher, for instance, nods yes once he/she wants that pitch suggested by the catcher or coach. The second input by the catcher may be used in order to give the pitcher location feedback.

Additionally, in kind, once the type of pitch is established, the system can be utilized to designate the pitch location and thus, one “touch or push” resulting as feedback to the catcher as a single pulse or vibration may indicate the location—“outside.” Two pushes or touches by transmitter apparatus which is felt as 2 pulses or vibrations etc. via the pitcher's receiver apparatus.

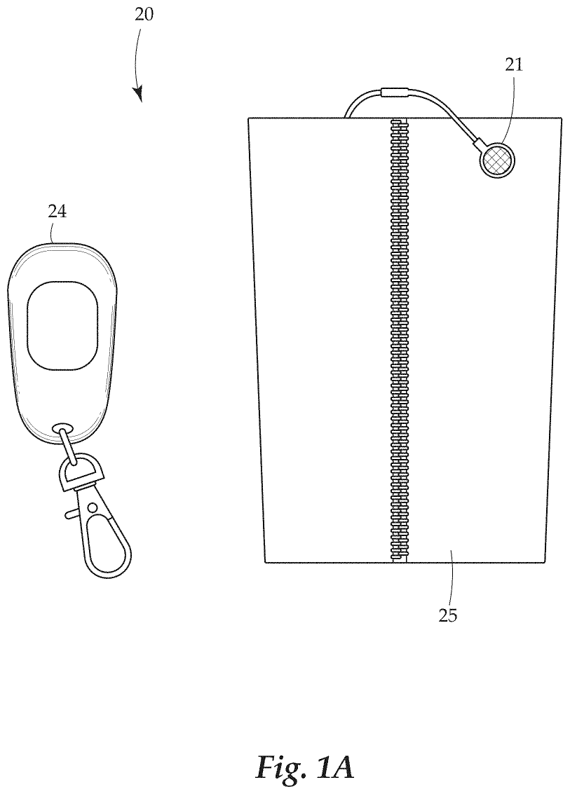

FIG. 1A illustrates the fully assembled components of one embodiment of the communication system 20 including a vibration disc 21, and a compression wrist cuff 25 which can suffice as a transmitter or receiver. Not seen are the antenna, the battery case and the transmitter. Also, the vibration disk will be normally unseen during usage.

FIG. 1B illustrates the disassembled components of one embodiment of the communication system 20 including a vibration disc 21, an antenna 22, a battery case 23 wherein the battery is housed, a transmitter device 24 and a compression wrist cuff 25 which can suffice as a transmitter or receiver house the entirety of a transmitter or a receiver. In proper operation the signal receiving device and a signal conditioning device.

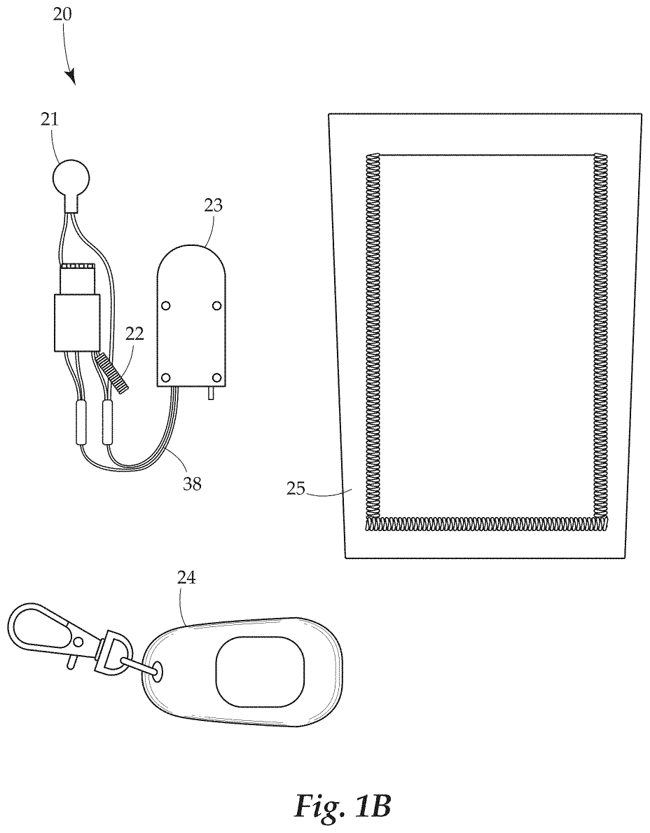

FIG. 2 illustrates a diagram depicting the internal structures of one embodiment of the transmitter and the receiver-based communication system 10 of the present apparatus. The constituent parts are illustrated including a keychain type transmitting apparatus 11, a fingernail-sized printed circuit board receiver set 12, which in one embodiment may comprise an antenna 16, a 2×CR2032 (dime-shaped) button battery 13, a vibratory motor 14 which receives an internally conditioned signal from the receiver signal conditioner component 15 in order to yield a user recognizable output vibration. In one embodiment, the transmitter apparatus 11 to be utilized may be a commercial off the shelf (COTS) product repurposed for this prototype.

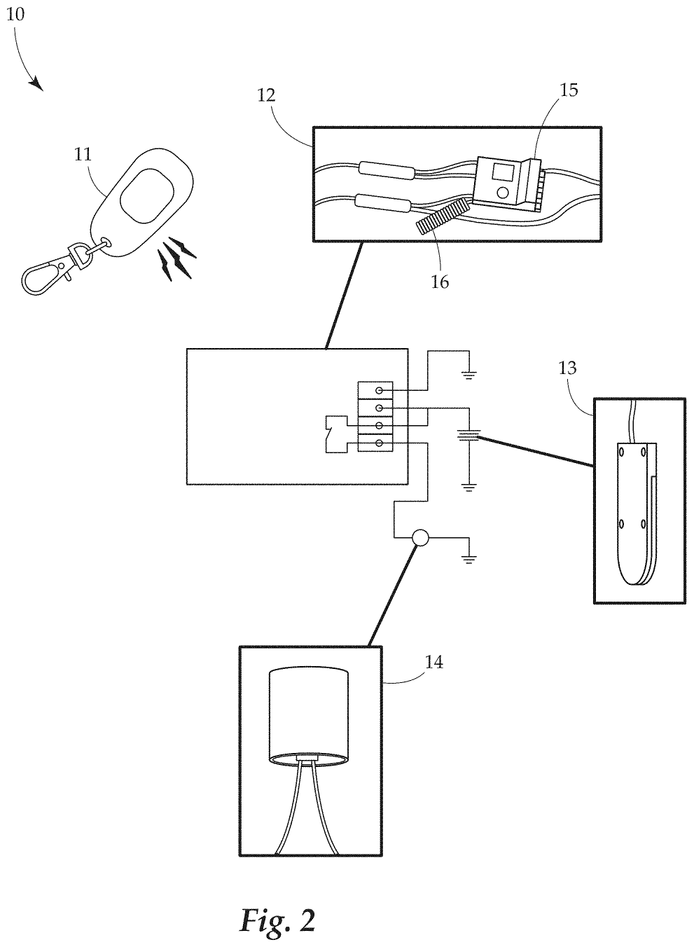

FIG. 3 illustrates the embodiment of FIG. 2 in a unitary form with the single-buttoned keychain-sized transmitter or a pressure sensitive actuator, a receiver integrated with several components, including a fingernail-sized COTS PCB, two CR2032 battery, a vibration motor and a waterproof housing unit.

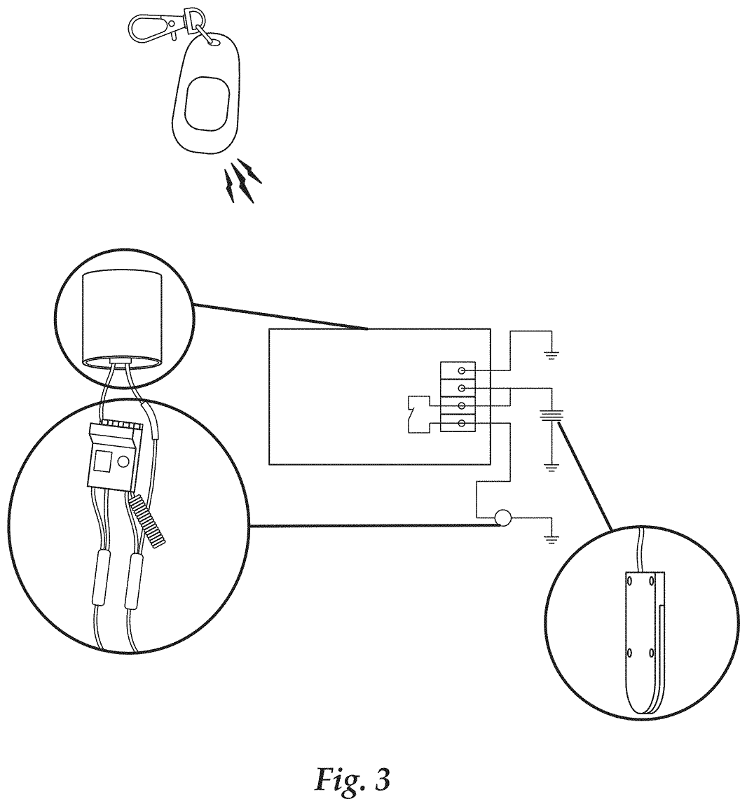

FIG. 4 illustrates the disassembled components of one embodiment of the communication system 80 including a transmitter 81, a compression wrist cuff 82 and a vibration disc 81, The compression wrist cuff which can suffice as a transmitter or receiver housing, but in the instant embodiment, the compression wrist cuff is being used a receiver system housing.

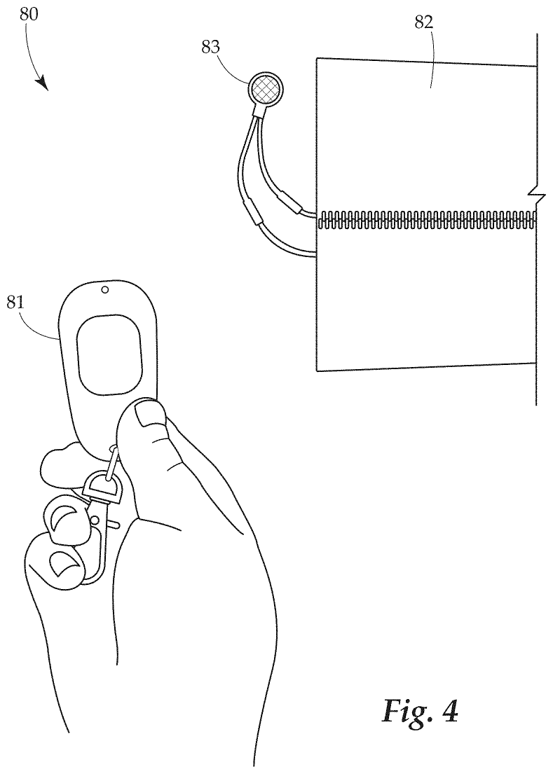

FIG. 5 shows a schematic view of a first embodiment of the system in the form of a functional block circuit diagram 60. The components of transmitter receiver circuit in one embodiment of the system and their interaction include a transmitter output stage 61, which receives a transmission signal at the input end, is connected at the output end via a transmission band-transmitting filter 62 to a feedpoint 63a of a combined transmission/reception antenna 63. A reception band-transmitting filter 64 is connected between the feedpoint 63a of the antenna 63 and the input of a reception pre-amplifier 65, at whose output a pre-amplified reception signal is made available. The transmission curves of the transmission band-transmitting filter 62 and of the reception band-transmitting filter 64 have a frequency spacing from one another which is predetermined by the standard of the mobile phone system.

According to the GSM standard (which, however, also provides for time-division duplex between the reception and transmission mode), this spacing is, for example, 45 MHz. The two transmitting filters 62, 64 form together a duplex filter, of which, however, less is demanded in terms of the edge steepness of the filter characteristic curves with the proposed solution than is demanded with a conventional mobile phone duplex filter, and which can therefore be implemented using integrated silicon technology.

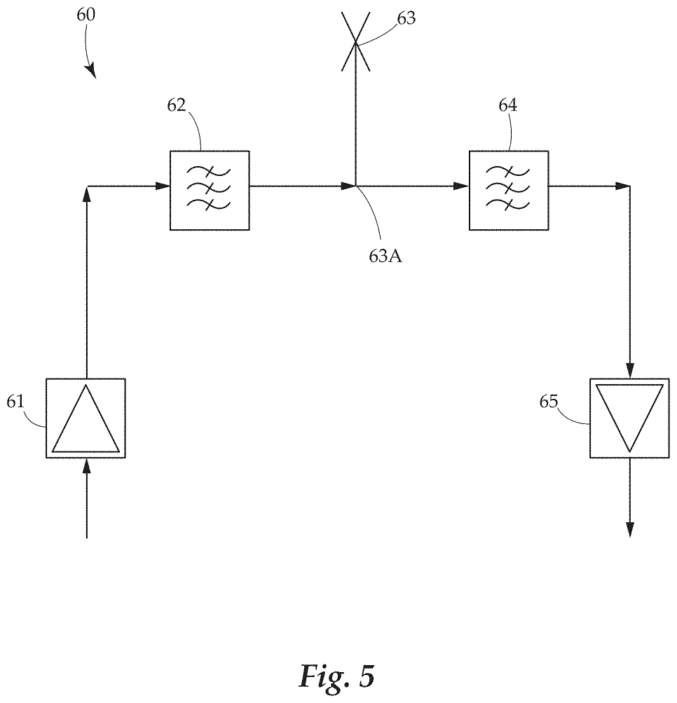

FIG. 6 illustrates block descriptive diagrams of numerous embodiments of systems to be utilized. A radio frequency (RF) system 70 refers to a wireless electromagnetic signal used as a form of communications.

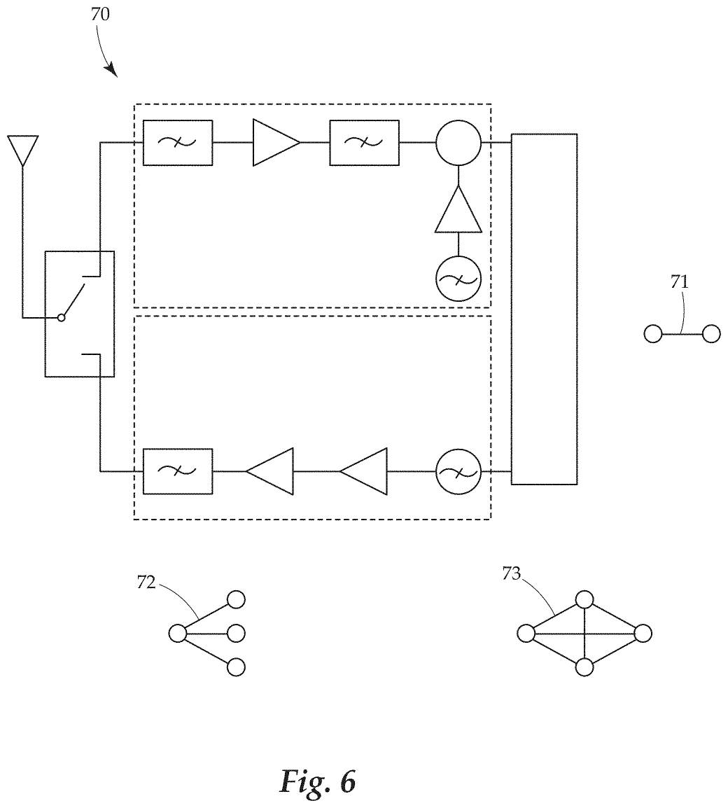

FIG. 7 illustrates some possible placement alternatives for transmitting and receiving apparatuses 30. Some placement alternatives include shoulders 31, wrists 32, hips 33, knees 34 and ankles 35.

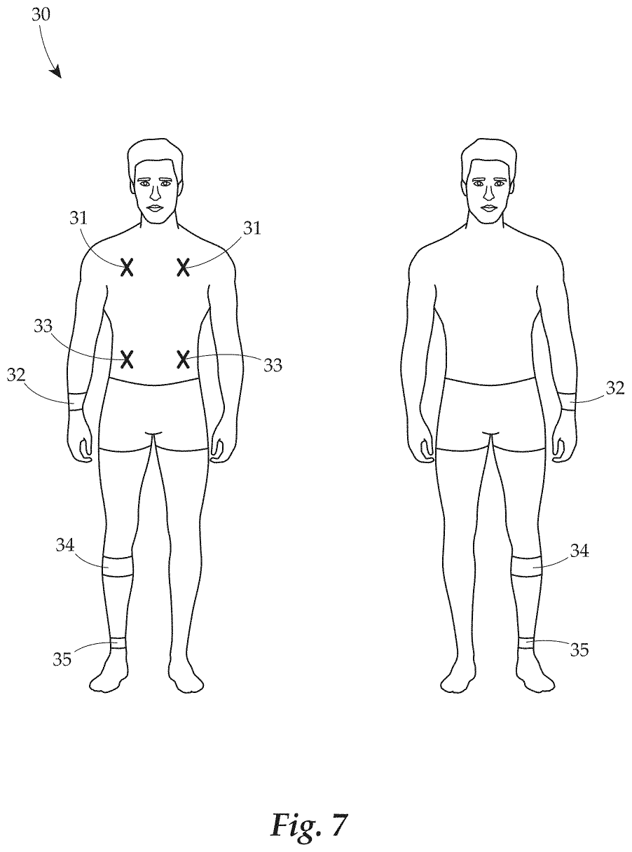

FIG. 8 illustrates some possible placement alternatives for transmitting and receiving apparatuses and particularly illustrates a transmitting or receiving apparatus, which may be a remote signal button 40, located within a baseball/softball glove 41 of player.

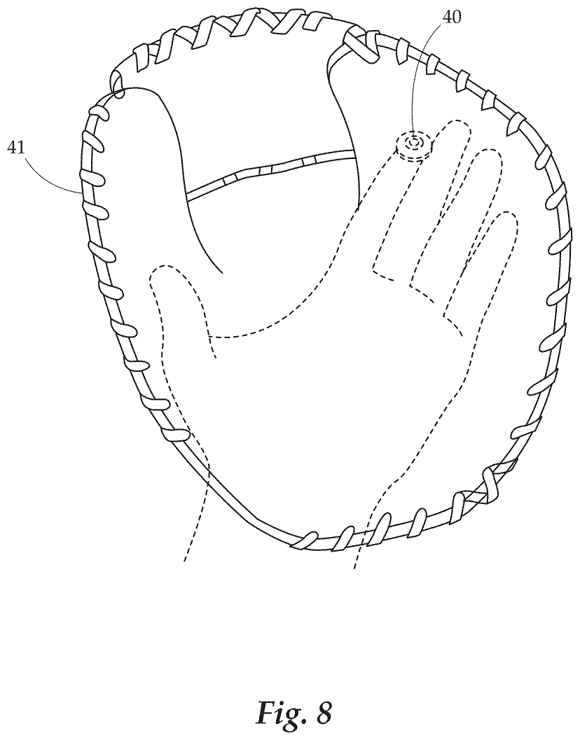

FIGS. 9A-9D illustrates some possible usage alternatives for the transmitting and receiving apparatuses. In usage one embodiment, communication from catcher to pitcher 51 is illustrated. In an additional second embodiment, communication from dugout to catcher and pitcher 52 is illustrated. Also, in another embodiment communication from catcher to pitcher and infielders 53 is illustrated. Furthermore, in still another embodiment communication from dugout to catcher, pitcher, and infielders 54 is shown.

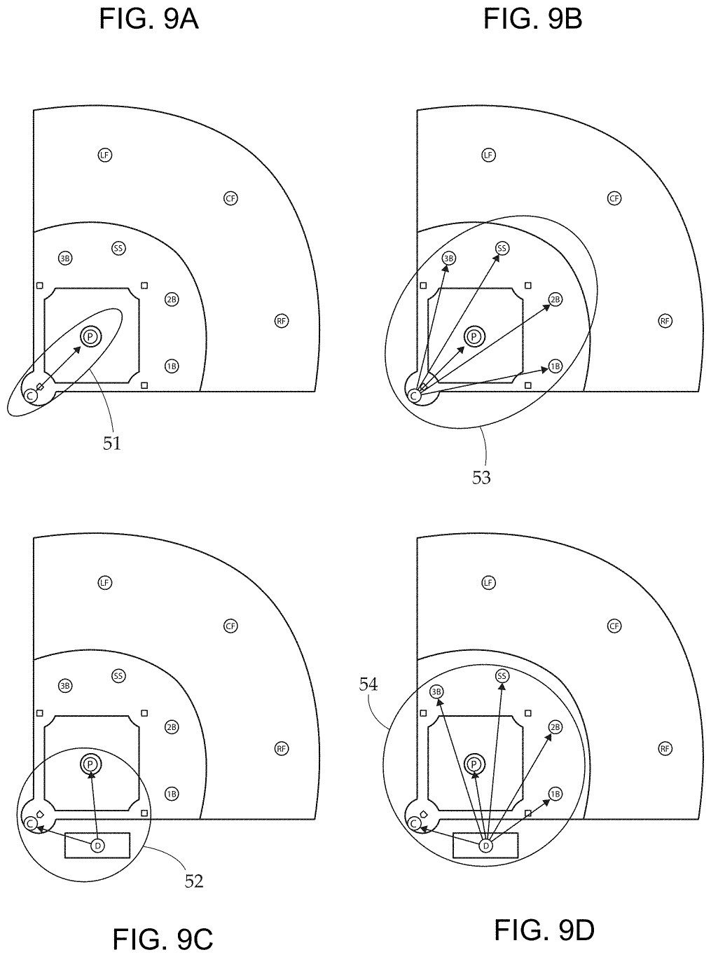

FIG. 10 is a diagram 105 displaying the human ear with an embodiment of a bone conduction device installed. The temporal bone 110 of the skull with a bone conduction device 112 attached to it. The bone conduction device 112, receives a signal from the transmitting system and allows sound waves 114, to bypass the outer ear 116, pinna 118, ear canal 120, and ear drum 122 through bone conduction. Instead, sound is transferred directly to the cochlea 124 which send stimulation to the bones, muscles, and nerves within inner ear 126 and then to the brain 128, thus getting the signal to the receiving entity a soundless and undetectable manner.

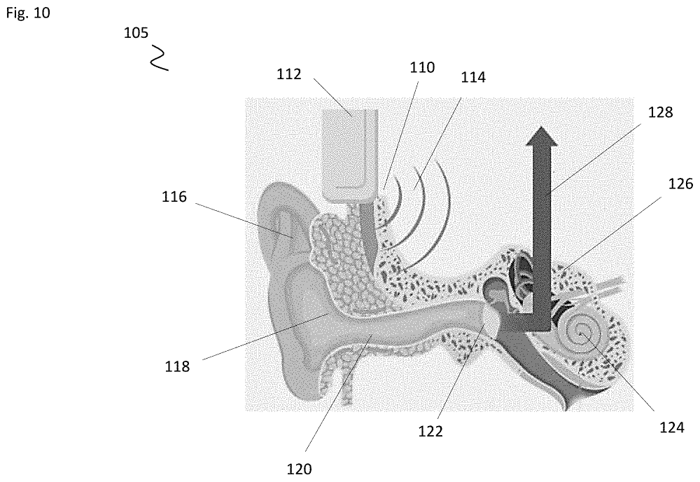

FIG. 11 is a diagram illustrating the vibration of air 130 as emanated by a normal sound for processing by the human ear, without a bone conduction device installed. Obviously, this means of transfer of communication is not secure in any manner as state-of-the-art listening devices afford the capabilities of collecting and processing of the distant and minute sounds.

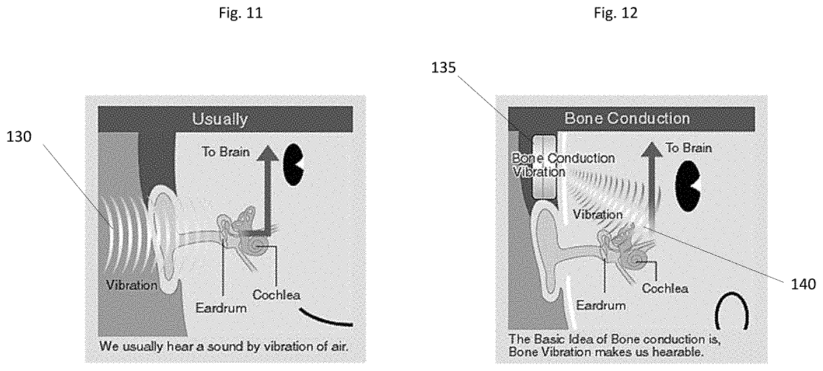

FIG. 12 is a diagram illustrating the vibration 140 through a bone conduction device 135 processing through the human ear and this means of transfer of communication is highly secure and cannot be detected in any manner by state-of-the-art listen devices and the vibration is now internal.

In one embodiment, a covert communication system comprising, at least one transmitter set comprising at least one actuation button; and at least one internal battery pack; at least one receiver set comprising an antenna; a battery and battery case; a signal receiving device; a signal conditioning device; a vibration disc; and a housing; wherein the antenna, the battery and battery case, the signal receiving device and the vibration disc are contained within the housing.

In one embodiment, a covert communication system is illustrated comprising a housing to retain a receiver mechanism, and the housing may be chosen from including but not limited to compression wrist cuffs, wrist bands or tension bands. In one embodiment, he covert communication system of claim 1 wherein the at least one receiver may comprise, a COTS PCB, a 2×CR2032 battery, a signal conditioner, a vibration motor and a waterproof housing.

The transmitter of the covert communication system may produce a set of covert non-visual and non-audio feedback to the pitcher's receiver, which is revealed to the pitcher as a vibratory output, disposed to correspond to an impulse from an initiator sending a signal by, in one embodiment pushing a button.

In one embodiment of the covert communication system, the one or more receiver may receive a haptic feedback upon actuation of the button, or other such actuation mechanism and wherein the at least one transmitter may utilize numerous technologies, including rolling code technology and thus may generate a new security code every time a user's input device is actuated or utilized.

The covert communication system may also embody a system wherein one or more transmitter utilizes a momentary switch that provides power to a transmitter IC chip with a RF/Bluetooth output antenna to provide robust signals and wherein concurrent to use of the momentary switch, one or more receiver device may utilize a battery driven power source with a corresponding RF/Bluetooth receiver IC chip that activates a piezo electric motor to vibrate.

Further, the one or more transmitter device may utilize the at least one receiver set and the at least one transmitter are integrated into a user's apparel, wherein the receiver may rest on shoulders or collar bone such that the covert communication system utilizes bone conduction technology to receive a signal and convert into sound only audible to the user. Additionally, in the covert communication system, the one or more receiver set and the one or more transmitter set may be integrated into a set of apparel selected from the group consisting of gloves, mitts, wrist bands, waistbands, or socks.

In one embodiment, the covert communication system may utilize three pitch types: dot, dot dot, and dash to differentiate different types of signals. Also the transmitter set may utilize a durable and sweatproof silicone rubber wristband, wherein the wristband includes a battery capable of operation in a range between ten and twelve hours, and the battery may be chosen from numerous systems, including but not limited to a common CR2032×3 volt, a lithium coin battery (button battery) or a rechargeable lithium ion that could be charged either wirelessly or through wired charging apparatus.

In differ versions of the covert communication system a vibrating receiver may be worn on a forearm/wrist, ankle, lower leg, lower/center back, hip (belt line), collar bone, and neck and the vibrating receiver may emit a vibration strong enough to be detected by the sensory system of the wearer, and wherein the covert communication system does not emit an audibly discernable signal. The vibrating receiver may be composed of a water and heat resistant material and include an on/off switch in order to prevent transmission of improper signals and preserve battery power when not in use.

The covert communication system may include a method of transmitting signals utilizing the steps of providing at least one user-wearable transmitter device and at least one user-wearable receiver device; and transmitting a non-audible and non-visual communication signal from a user-wearable transmitter device to at least one user-wearable receiver device

The method of transmitting signals may also include the step of synchronizing the at least one transmitter and the at least one receiver with an encryption system disposed to create secured communication network and the step of defining a range specified for the particular communication usage. For usage case under these methods of transmitting signals, the system may utilize a communication medium chosen from, but not limited to, cellular, WIFI, and Remote Frequency Identification (“RFID”).

The method of transmitting signals according to claim 18 uses Frequency-hopping Spread Spectrum (FHSS) to rapidly change the frequency among many distinct frequencies occupying a large spectral band in order to avoid interference, to prevent eavesdropping, and to enable code-division multiple access (CDMA) communications.

What is claimed is:

1. A covert communication system comprising:
at least one transmitter set comprising:
at least one button; and
at least one internal battery pack;
at least one receiver set comprising:
an antenna;
a battery and battery case;
a signal receiving device;
a signal conditioning device;
a vibration disc; and
a housing; wherein the antenna, the battery and battery case, the signal receiving device and the vibration disc are contained within the housing.

2. The covert communication system of claim 1 wherein the housing comprises an article selected from the group consisting of a compression wrist cuff, wrist bands or tension bands.

3. The covert communication system of claim 1 wherein the at least one receiver comprises:
a COTS PCB;
a 2×CR2032 battery;
a signal conditioner;
a vibration motor; and
a waterproof housing.

4. The covert communication system of claim 1 wherein the transmitter produces a set of covert non-visual and non-audio feedback to the pitcher's receiver, which is exhibited to the pitcher as a single vibration if an initiator pushes the button once.

5. The covert communication system of claim 4 wherein the at least one receiver receives haptic feedback upon every push of the button.

6. The covert communication system of claim 4 wherein at least one transmitter utilizes rolling code technology by generating a new security code every time a user's input device is used.

7. The covert communication system of claim 4 wherein at least one transmitter utilizes a momentary switch that provides power to a transmitter IC chip with a RF/Bluetooth output antenna to provide robust signals.

8. The covert communication system of claim 7 wherein concurrent to use of the momentary switch, the at least one receiver utilizes a battery driven power source with a corresponding RF/Bluetooth receiver IC chip that activates a piezo electric motor to vibrate.

9. The covert communication system of claim 4 wherein at least one transmitter utilizes the at least one receiver set and the at least one transmitter are integrated into a user's apparel, wherein the receiver may rest on shoulders or collar bone such that the covert communication system utilizes bone conduction technology to receive a signal and convert into sound only audible to the user.

10. The covert communication system of claim 1 wherein the at least one receiver set and the at least one transmitter set are integrated into a set of apparel selected from the group consisting of gloves, mitts, wrist bands, waistbands, or socks.

11. The covert communication system according to claim 1 wherein the system utilizes three pitch types: dot, dot dot, and dash to differentiate different types of signals.

12. The covert communication system according to claim 1 wherein the at least one transmitter set utilizes a durable and sweatproof silicone rubber wristband, wherein the wristband comprises a battery capable of operation in a range between ten and twelve hours.

13. The covert communication system according to claim 1 wherein the battery is selected from the group consisting of a common CR2032—3 volt, a lithium coin battery (button battery) or a rechargeable lithium ion that could be charged either wirelessly or through wired charging apparatus.

14. The covert communication system of claim 1 further comprising a vibrating receiver wherein the vibrating receiver can be worn on a forearm/wrist, ankle, lower leg, lower/center back, hip (belt line), collar bone, and neck.

15. The covert communication system of claim 14 wherein the vibrating receiver emits a vibration strong enough to be detected by the sensory system of the wearer, and wherein the covert communication system does not emit an audibly discernable signal.

16. The covert communication system of claim 15 wherein the vibrating receiver is disposed of a water and heat resistant material.

17. The covert communication system of claim 1 wherein the vibrating receiver comprises an on/off switch in order to prevent transmission of improper signals.

18. A method of transmitting signals using the covert communication system according claim 1 comprising the steps of:
providing at least one user-wearable transmitter device and at least one user-wearable receiver device; and
transmitting at least one non-audible and non-visual communication signal from a user-wearable transmitter device to at least one user-wearable receiver device.

19. The method of transmitting signals of claim 18 further comprising the step of synchronizing at least one transmitter with at least one receiver to enable a secured and reliable communication network.

20. The method of transmitting signals of claim 18 further comprising the step of encrypting the at least one non-audible and non-visual communication signal.

21. The method of transmitting signals of claim 18 wherein the at least one non-audible and non-visual communication signal is transmitted up to and including a distance of 400 feet.

22. The method of transmitting signals according to claim 18 uses cellular, WIFI, and RF to improve signal strength.

23. The method of transmitting signals according to claim 18 uses Frequency-hopping Spread Spectrum (FHSS) to rapidly change the frequency among many distinct frequencies occupying a large spectral band in order to avoid interference, to prevent eavesdropping, and to enable code-division multiple access (CDMA) communications.

24. A covert communication system comprising:
at least one transmitter set comprising:
at least one button; and
at least one internal battery pack;
at least one receiver set comprising:
an antenna;
a battery and battery case;
a bone conductive signal receiving device;
a signal conditioning device;
a vibration disc; and
a housing; wherein the antenna, the battery and battery case, the signal receiving device and the vibration disc are contained within the housing.
